(19) United States
(12) Patent Application Publication
(10) Pub. No.: US 2026/0199931 A1
(43) Pub. Date: Jul. 16, 2026

(54) CHUB ASSEMBLY FOR A MULTI-COMPONENT PRODUCT

(71) Applicant: Zephyros, Inc., Romeo, MI (US)

(72) Inventor: Daniel A. Mckenzie, Kitchener (CA)

(21) Appl. No.: 19/134,885

(22) PCT Filed: Jan. 26, 2024
(86) PCT No.: PCT/US2024/013060

§ 371 Date: Jun. 2, 2025

Related U.S. Application Data
(60) Provisional application No. 63/441,225, filed on Jan. 26, 2023.
(60) Provisional application No. 63/468,908, filed on May 25, 2023.

(51) Int. Cl. B05C 17/005; B05C 17/01

(52) U.S. Cl. CPC B05C 17/00553; B05C 17/00513; B05C 17/00586; B05C 17/01

(57) ABSTRACT

A dispenser assembly, comprising a cap portion configured to receive one or more chubs containing one or more components for dispensing; and an elongated mounting tube portion having a first end and a second end and a longitudinal axis and configured to carry the plunger and cap with the one or more elongated packages positioned between the cap and plunger and a variable internal volume defined between the plunger and the cap portion. The cap portion is configured to: (i) sealingly receive the one or more chubs (e.g., at or an end portion of the one or mor chubs); (ii) allow and direct chub contents to flow at least partially therethrough; (iii) maintain separation between the contents of the one or more chubs; (iv) maintain orthogonally oriented alignment of the cap portion throughout dispensing; (v) be arranged adjacent to the tube in a manner that enables the assembly to be transported and loaded into an applicator and to be disassembled manually; (vi) receive and/or carry a piercing device; and optionally (vii) meter the one or more components.

### RELATED APPLICATIONS

This application claims the benefit of the filing dates of U.S. Provisional Application Nos. 63/441,225, filed Jan. 26, 2023, and 63/468,908, filed May 25, 2023. The contents of both applications are hereby incorporated by reference herein in their entirety and for all purposes.

### FIELD OF THE INVENTION

The invention relates generally to the application of viscous or semi-viscous materials using a caulking gun, and in an embodiment to a chub assembly for a multi-component product, where separate components of the product are stored in separate chubs for subsequent mixing and application to a surface through use of a caulking gun.

### BACKGROUND OF THE INVENTION

Caulking guns have been used for a long period of time to apply a wide variety of materials to a host of different surfaces, for many different applications. One of the more common uses of caulking guns is to apply caulking, silicone, sealants, or other such materials in construction and manufacturing applications. Traditionally, the material to be applied is received or stored within a paper, cardboard, or plastic cylindrical tube having a nozzle and/or applicator at one end. The tube may be inserted into the body of a caulking gun, which may be a manual caulking gun, an electric caulking gun, or pneumatic caulking gun. Once inserted into the caulking gun a plunger is inserted into the end of the cylindrical tube, opposite to the nozzle and/or applicator. Pressure can then be applied to the plunger to force the material stored within the tube longitudinally within the tube and through the nozzle and onto a desired surface.

More recently, others have begun to use caulking guns that accommodate two or more tubes where the contents of the tubes are expelled generally simultaneously through a common nozzle or mixing port so as to apply a mixture of the multiple materials for a particular application. For example, in some cases it may be desired to apply a two-component epoxy for a particular purpose. In such cases each of the two components of the epoxy can be stored in separate cylindrical tubes that are fixed at one end to a common nozzle or applicator, and wherein a pair of plungers drive the contents from the tubes through the applicator, which both mixes the components and applies them in a desired manner.

Even more recently, others have begun to replace the traditional cylindrical tubes used in a caulking gun with thin-walled, flexible, elongate cylindrical packages filled with the desired material. Such packages are at times referred to as chubs or sausages as they tend to generally resemble a sausage, having contents received within a thin flexible sleeve with both ends crimped or otherwise sealed. Chubs or sausages of this nature can be advantageous from the perspective of potentially being less expensive to manufacture in that they typically involve the use of less material. The use of less material can also make the chubs or sausages more environmentally friendly than traditional cylindrical tubes as they can represent a lower volume of waste to be disposed of.

While such chubs have presented certain advantages, they have also presented challenges for manufacturers and end-users. For example, when two or more chubs are glued or otherwise secured to a common end cap or nozzle (as may be the case where a multi-component product is to be extruded through a single nozzle) shipping and handling difficulties can ensue as the thin walls of the chubs exhibit little inherent rigidity. That is, unlike the more traditional cylindrical tubes constructed from paper or a semi-rigid plastic, a plurality of thin walled, flexible, chubs secured to a common end cap can be inherently weak and can present a potential for the connection of one, or both, of the chubs to be damaged. Further, where two or more chubs are secured to a common end cap and then inserted into a caulking gun or are inserted into a rigid cylindrical tube, pressure applied to the “free” ends of the chubs by a plunger can cause one or more of the chubs (often the chub containing the less viscous material) to “buckle”, be displaced, or otherwise behave in a manner that causes the plunger to apply greater pressure against one chub, potentially resulting in an undesired ratio of material expelled from the respective chubs and a mixing of components in an undesired ratio. This phenomenon can be more significant where the individual chubs are of different diameters, as is often the case where the mixing ratios of the component parts is other than 1:1.

There thus continues to be a need for further improvements in products used within caulking guns, including chub assemblies for multi-component mixing and application.

### SUMMARY OF THE INVENTION

The paragraphs set forth below include aspects of the present teachings that may be present on their own or may be combined with teachings of other paragraphs set forth below. Any number of the paragraphs set forth below may be combined but should not be viewed as requiring combination with others despite addressing similar aspects of the teachings.

The teachings herein provide for a dispenser assembly, comprising a cap portion configured to receive one or more chubs containing one or more components for dispensing; and an elongated mounting tube portion having a first end and a second end and a longitudinal axis and configured to carry the plunger and cap with the one or more elongated packages positioned between the cap and plunger and a variable internal volume defined between the plunger and the cap portion. The cap portion is configured to: (i) sealingly receive the one or more chubs (e.g., at an end portion of the one or more chubs); (ii) allow and direct chub contents to flow at least partially therethrough; (iii) maintain separation between the contents of the one or more chubs; (iv) maintain orthogonally oriented alignment of the cap portion throughout dispensing; (v) be arranged adjacent to the tube in a manner that enables the assembly to be transported and loaded into an applicator and to be disassembled manually; (vi) receive and/or carry a piercing device; and optionally (vii) meter the one or more components.

The cap portion may be configured to include one or more discrete flow paths that are physically separated from one another while enclosed by the cap within the assembly.

The cap portion may have at least two discrete flow paths defined by a plurality of longitudinally adjoining chambers that are each defined by an internal wall structure so that the chambers are in fluid communication with each other and progressively narrow in cross sectional area in stepped decrements progressing toward a distal end, and also converging radially inward.

The cap portion may include a threaded mixing nozzle mount located at or near the distal end, and optionally defines the distal end of the cap.

The nozzle mount may have a threaded neck portion and may include a longitudinally extending inner partition wall to maintain physical separation of contents of respective chubs until the contents are expelled external of the cap.

Any nozzle mount of the cap portion may include a longitudinally extending inner partition wall to maintain physical separation of contents of respective chubs until the contents are expelled external of the cap, and optionally wherein the inner partition wall extends distally such that it would penetrate through a plane that is defined within a mixing nozzle that is threadingly secured to the nozzle mount.

Separation of the contents of the chubs may be maintained until the contents are expelled from the cap and located in a mixing nozzle.

The assembly may be configured to dispense two components for mixing to form an epoxy adhesive.

The cap portion may include a proximal end portion that includes a plurality of chub receiving tubes, into which chubs can be sealingly inserted and optionally held in place by an adhesive.

The cap portion may include a proximal end portion that includes a plurality of chub receiving tubes, into which chubs can be sealingly inserted and optionally held in place by an adhesive, and wherein the cap portion includes a nozzle mount distally located relative to the chub receiving tubes and one or more chambers located at least partially between the nozzle mount and the chub receiving tubes into which a distal end (and optionally a clip) of a chub is located during dispensing.

The assembly may include a plunger wherein the plunger is configured to: (A) (i) bear against an inside surface of the tube; (ii) be translated by an external force in a fore and/or aft direction along the longitudinal axis; (iii) remain aligned with the longitudinal axis during and throughout dispensing; (iv) remain generally orthogonally oriented during fore and/or aft translation; (v) avoid pressure build-up within the tube portion as it translates; (vi) apply a dispensing pressure to the one or more packages; and (vii) maintain the package within the variable internal volume throughout a dispensing operation; and/or (B) include an interior wall having (i) a diameter (or other largest dimension in a plane transverse to the longitudinal axis of the tube portion), and (ii) an outer periphery that includes a forward and/or rearward extending circumferential flange, and the forward and/or rearward extending flanges optionally each extend forwardly and/or rearwardly along the direction of the longitudinal axis in an amount that is at least 10 to 50% of the diameter or other largest dimension and/or the forward and/or rearward extending flanges optionally each include a radially extending slot.

The tube portion may have a constant profile, optionally cylindrical, along a majority of its length.

The assembly may include a plurality of chubs that are aligned parallel with each other within the tube portion and sealingly attached to the cap portion at or near the distal ends of the chubs, and optionally wherein the chubs are assembled together and kept in place by a sheath or other band that wraps around two or more of the chubs and/or an adhesive bond adjoining the chubs to each other.

A single chub may be received by the cap portion. Exactly two chubs may be received by the cap portion. Exactly three chubs may be received by the cap portion.

All chubs may have the same diameter. One more of the chubs may have a diameter that differs from one or more other chubs.

The cap may be adapted to meter the one or more components.

At least two chubs may be received by the cap portion and the chubs may be wrapped with a shrink wrap.

The shrink wrap may cover a large portion of the chubs.

The shrink wrap may comprise a single layer of material.

The shrink wrap may comprise a plurality of layers.

The cap portion may be adhesively bonded to the one or more chubs.

The teachings herein are further directed to a method of dispensing an adhesive that includes steps of inserting a chub containing ingredients for forming a bead into an assembly as described herein, locating the assembly into an applicator capable of applying pressure against a plunger, puncturing the chub, and applying pressure to force the ingredients out of the chub through an opening made by the puncturing and through the cap.

The method may include steps of inserting a plurality of chubs containing different ingredients for forming a bead of a multi-component adhesive into an assembly as described herein, locating the assembly into an applicator capable of applying pressure against a plunger, puncturing the chub, and applying pressure to force the ingredients out of the chub through an opening made by the puncturing and through the cap; and preventing mixing of the different ingredients prior to expulsion from the cap.

The following general comments are applicable to each of the embodiments.

The chubs may be pre-filled with contents prior to inserting the chubs into a gun.

It is contemplated that after attaching a chub to a cap, that there is no additional step of filling the chub with any contents.

The tube may be insertable and separate from the gun.

A single plunger and/or a single plunger rod may drive multiple chubs.

The chubs may be carried in a common tube.

An outer surface of the tube may be without grooves.

The assembly may be free of any clamping device that clamps an end of a chub between two or more sequential dispensing operations.

The tube may have a side wall that extends at least 5 mm, 10 mm, 15 mm, or 20 mm along an inserted chub. The tube may have a side wall that extends less than 40 mm, 35 mm, 30 mm, or 25 mm along an inserted chub.

The cap may be inserted within the tube.

The tube may be transparent.

The tube may be polymeric.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper side perspective view of a caulking gun used to apply material through the movement of a plunger through a cylindrical tube to expel the material through a nozzle.

FIG. 2 is in an upper side perspective view of a cylindrical tube for use in a caulking gun having a mixing nozzle at one end.

FIG. 3 is a sectional view taken along the line 3-3 of FIG. 2.

FIG. 4 is a sectional view taken along the line 4-4 of FIG. 2.

FIG. 5 is a sectional view taken along the line 5-5 of FIG. 3.

FIG. 6 is an exploded view of the cylindrical tube shown in FIG. 2.

FIG. 7 is an assembled view of the chubs, end cap, and nozzle of FIG. 6.

FIG. 8 is an upper side perspective view of the end cap and nozzle of FIG. 2.

FIG. 9 is a lower perspective view of the end cap of FIG. 8.

FIG. 10 is a plan view of the end cap of FIG. 8.

FIG. 11 is a sectional view taken along the line 11-11 of FIG. 10.

FIG. 12 is an exploded view of the end cap and nozzle of FIG. 8.

FIG. 13 is an upper side perspective view of alternate embodiment of the cylindrical tube shown in FIG. 2.

FIG. 14 is a sectional view taken along the line 14-14 of FIG. 13.

FIG. 15 is a sectional view taken along the line 15-15 of FIG. 10.

FIG. 16 is a sectional view taken along the line 16-16 of FIG. 14.

FIG. 17 is an exploded view of the cylindrical tube shown in FIG. 13.

FIG. 18 is an assembled view of the chubs, end cap, and nozzle of FIG. 17.

FIG. 19 is an upper side perspective view of the end cap and nozzle of FIG. 13.

FIG. 20 is a lower perspective view of the end cap of FIG. 13.

FIG. 21 is a plan view of the end cap of FIG. 13.

FIG. 22 is a sectional view taken along the line 22-22 of FIG. 21.

FIG. 23 is an exploded view of the end cap and nozzle of FIG. 19.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. Percentages herein refer to weight percent, unless otherwise indicated.

The present invention may be embodied in a number of different forms. The specification and drawings that follow describe and disclose some of the specific forms of the invention.

With reference to the attached drawings, there will now be described various embodiments of the invention. Individual features depicted for one embodiment may be employed in a combination with a different embodiment. For example, without limitation, a nozzle and/or end cap of one embodiment may be substituted for a respective nozzle and/or end cap of another embodiment. Moreover, nothing herein prevents the adaptation of the embodiments herein to accommodate the employment of more than two chubs. For example, the embodiments herein envision nozzles and/or end caps configured to expel material (e.g., simultaneously) through three, four, five, six, seven or more chubs. Embodiments herein envision nozzles and/or end caps configured to expel material through (e.g., simultaneously) twelve, eleven, ten or fewer chubs.

The assembly embodiments of the present teachings may be employed in any of a number of different applicators. The applicators may be manually operated and/or operated by a motor to drive a plunger to compress one or more containers (referred to herein as “chubs”) that include contents and cause each resulting compressed container to expel its contents through a nozzle. The contents of the dispensing assembly may be flowable. For example, they may have a liquid, paste, or gel consistency at an ambient temperature for a particular application (e.g., room temperature for an indoor environment). The chubs generally are elongated, extending along a longitudinal axis. They may be generally cylindrical. They may have a diameter (D) measured in a plane that is transverse to the longitudinal axis, and a length (L) measured from one end to an opposite end along the longitudinal axis. The ratio of L:D may range from 1.5:1 to 20:1, preferably 2:1 to 15:1, and still more preferably 3:1 to 10:1 (e.g., about 4:1, about 5:1, about 6:1, or about 7:1).

The dispensing assemblies of the present teachings may include only a single tube. For example, the dispensing assemblies may have a single tube within which a plurality of chubs are contained. They may be contained within the single tube side by side with each other (e.g., each aligned parallel with the longitudinal axis). The dispensing assemblies may include a plurality of chubs that are not coaxially aligned. The dispensing assemblies may have no coaxially aligned chubs.

The cap may be press fit into the tube. The cap may have no structural feature for attaching to an external surface of the tube. The cap may be free of any threaded portion for attaching the cap to the tube.

The tube may define a continuously closed exterior surface so that chubs are enclosed within the tube. The tube may have one or more openings about its longitudinal axis. It is possible that the tube encloses the chubs over at least 60%, 70%, 80% or more of the overall external surface area of the tube. The tube may have a constant outer and/or inner profile (e.g., along at least 80%, 90% or its entire length).

The assemblies of the present teachings are adapted for use with dispensing guns. The assemblies have particularly attractive suitability for use with a conventional basic caulking or adhesive hand-held gun (manual or automatic). Such a gun may be a conventional type marketed for consumer use.

Guns useful herein may include a main carriage having a dispensing assembly holding portion having a longitudinal axis (along its longest dimension) and being adapted to receive a dispensing assembly of contents to be dispensed, a driving portion to apply pressure to the dispensing assembly to expel a portion of the contents (e.g., through a distal nozzle), and an operator handling portion that allows an operator to support (e.g., grippingly support) the gun and actuate the driving portion. The dispensing assembly holding portion may be configured to receive and carry a dispensing assembly that has a diameter less than 20 centimeters (cm), less than 10 cm, or even less than 5 cm.

An example of a suitable gun may thus have a gripping handle, a plunger rod (with a plunger at its distal end, and possibly a handle at a proximal end for longitudinally retracting the rod), a trigger operable by the operator to actuate forward translation (e.g., driven by a motor, driven pneumatically, driven by lever action (e.g., one or more lever arms configured to provide at least a 2:1, 4:1, 8:1, 16:1, 24:1 Or higher mechanical advantage, and/or one or more lever arms configured to provide no greater than a 50:1; 35:1; 25:1 mechanical advantage), driven by a ratchet or any combination thereof) of a plunger rod to drive a plunger against the dispensing assembly while a dispensing assembly is carried on the dispensing assembly holder carriage.

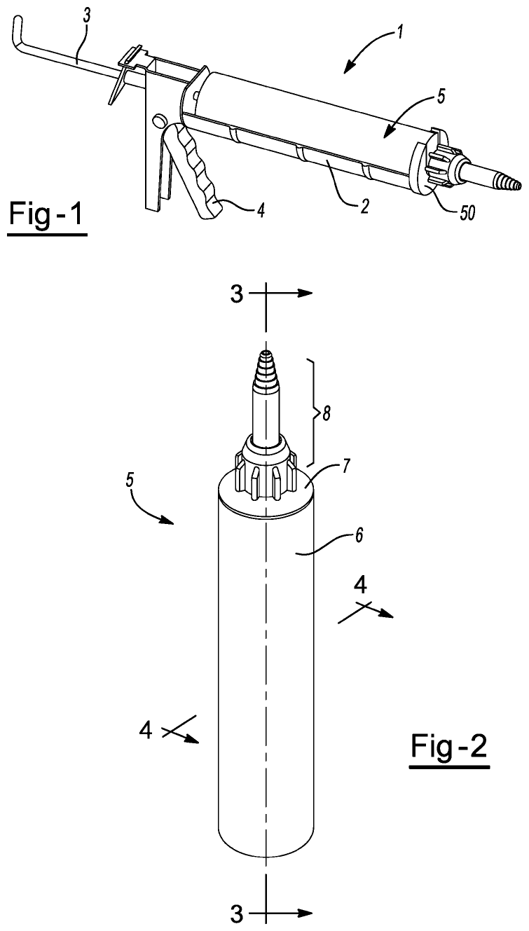

FIG. 1 shows one example of a relatively generic, manually operated, caulking gun 1 that is comprised a cylindrical body or frame 2 having a generally enclosed front end 50a and an opposite end 50b housing a plunger rod assembly 3 that is advanced through operation of a trigger handle 4. A tube assembly 5a having a first end 5b and an opposing second end 5c.

The teachings herein envision an assembly that includes a hollow elongated tube portion configured to receive one, two, three or more chubs. The hollow elongated tube portion may include a proximal end portion and a distal end portion. The proximal end portion may be configured to receive the chubs and/or a plunger (e.g., from the plunger rod assembly or its own plunger). It is possible that when the tube portion carries its own plunger that the plunger is configured to: (i) bear against an inside surface of the tube; (ii) be translated by an external force in a fore and/or aft direction along the longitudinal axis; (iii) remain aligned with the longitudinal axis; (iv) remain generally orthogonally oriented during fore and/or aft translation; (v) avoid pressure build-up within the tube as it translates; (vi) apply a dispensing pressure to the one or more packages; and/or (vii) maintain the chubs within the variable internal volume throughout a dispensing operation. For example, to achieve the above, the plunger may include a disc having a diameter (or other largest dimension in a plane transverse to the longitudinal axis of the tube portion) and an outer periphery that includes a forward and/or rearward extending circumferential flange. The forward and/or rearward extending flanges may each extend forwardly and/or rearwardly along the direction of the longitudinal axis in an amount that is at least 10 to 50% of the diameter or other largest dimension. The forward and/or rearward extending flanges optionally each include a radially extending slot. The distal end portion may be configured to receive an end cap. The hollow elongated portion may be defined as an elongated tube. The tube portion may be cylindrical or otherwise have a prismatic exterior and/or interior surface. It may have a multi-lobed exterior and/or interior surface that corresponds generally with individual chubs. It may have a plurality of individual bores parallel with the longitudinal axis, with one or more bores corresponding with an individual chub. The end cap may be configured to have one or more chubs attached to it, and preferably sealingly attached to it.

FIG. 2 illustrates a tube assembly (e.g., a cylindrical tube assembly) 5a that can be inserted into the cylindrical body 2 of caulking gun 1, in a manner as would be understood by one of ordinary skill in the art. Cylindrical tube assembly 5a is comprised generally of an elongate tube (e.g., an elongate cylindrical tube) 6a, enclosed at a first end 6b by an end cap 7 having mounted thereon a nozzle 8. It will be appreciated that when inserted into a caulking gun, the plunger 3 of the caulking gun 1 may be inserted into a second end 6c of cylindrical tube 6a, opposite to end cap 7, to permit material to be expelled through nozzle 8 through advancing the plunger. Though not shown in the drawings, it is contemplated that the plunger rod assembly 3 of FIG. 1 may drivingly engage a plunger as described herein that has been pre-assembled into and carried by the tube 6a.

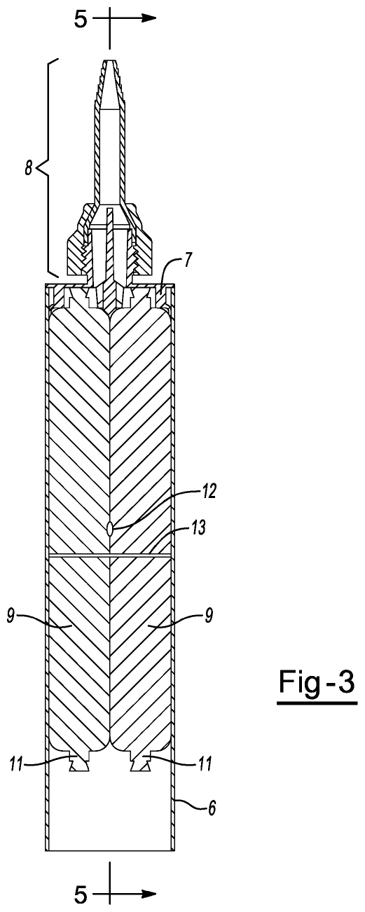

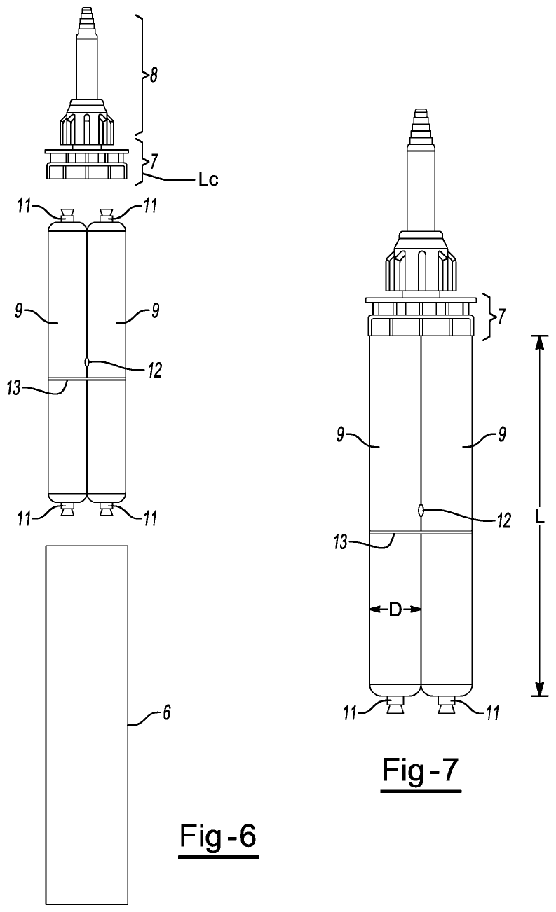

FIGS. 3 through 7 illustrate the internal components of cylindrical tube assembly 5a when a two-component material (component A in chub 9a and component B in chub 9b) is to be extruded through nozzle 8. In this embodiment, a pair of chubs 9a, 9b are releasably received within the interior 6d of cylindrical tube 6a. In the particular arrangement illustrated, chubs 9a, 9b are of the same diameter as would commonly be the case when it is desired to extrude a two-component product through nozzle 8, where the two components are mixed in an approximate 1:1 ratio. However, it will be appreciated that other numbers of chubs and relative sizes of chubs could be used where the respective components are to be mixed in a ratio other than the 1:1 ratio.

The construction of chubs 9a, 9b can be in accordance with any one of a variety of different known chub construction techniques. As well, the chubs can be formed from a variety of different materials and can be used to house a variety of different products. However, in each instance it is expected that the chub walls 10a will be formed from a thin, pliable, flexible, material, which in most cases is expected to be a plastic or other similar synthetic material. The chubs may have a metal layer. The chubs may have a first end 10b and an opposing second end 10c. The ends 10b, 10c of the chubs may be closed or sealed using a clip or other closure mechanism 11a. Alternately, the ends of the chubs could be enclosed through the use of adhesives, by heat welding, or through other known techniques.

One of the unique aspects of the present teachings is the provision of an end cap that is configured to perform any combination of functions to (i) sealingly receive the one or more chubs; (ii) allow and direct chub contents to flow at least partially therethrough; (iii) maintain separation between the one or more chubs; (iv) optionally selectively meter the one or more contents from the chubs; (v) maintain orthogonally oriented alignment of the end cap throughout dispensing; (vi) be arranged adjacent to the tube portion in a manner that enables the assembly to be transported and loaded into an applicator (e.g., a caulking gun) and to be disassembled manually (lightly attached); and/or (vii) receive and/or carry a structure that will puncture a chub and allowing the chub to tear upon application of a shear force.

By way of illustration, to achieve the above, it is possible that the end cap 7a may be configured to include one or more discrete flow paths 7b, 7c that are physically separated from one another while enclosed by the end cap 7a within the assembly. At least one (and possibly all) of the discrete flow paths 7b, 7c may be defined by a plurality of longitudinally adjoining chambers 7f, 7g that are each defined by an internal wall structure so that the chambers 7f, 7g are in fluid communication with each other and progressively narrow in cross sectional area progressing toward a distal end 7h, and also converging radially inward. A threaded mixing nozzle mount 7i may be located on the end cap 7a at or near the distal end 7h, and optionally may define the distal end 7h of the end cap 7a. The nozzle mount 7i may have a threaded neck portion 7j and may include a longitudinally extending inner partition wall 7k to maintain physical separation of contents of respective chubs until the contents are expelled external of the end cap 7a. For example, separation of the contents of the chubs may be maintained until the contents are located in a mixing nozzle 8. Thus, it is possible that the inner partition wall 7k extends distally such that it would penetrate through a plane that is defined within a mixing nozzle 8 that is threadingly secured to the nozzle mount 7i.

With particular reference to FIG. 7, in an embodiment of the invention one end of a pair of chubs 9a, 9b is adhesively or otherwise sealed or joined to end cap 7a. With the ends of the respective chubs 9a, 9b sealed to end cap 7a, the combined chub/end cap structure (with or without the nozzle attached) can be inserted into one end 6b of cylindrical tube 6a, effectively forming the structure shown in FIG. 3. Cylindrical tube 6a with the chub 9a, 9b/end cap 7a structure therein can then be inserted into caulking gun 1 with end cap 7a being received against enclosed end 50 of the caulking gun, such that the plunger rod 3 can be received into the opposite end 6c of cylindrical tube 6a. It will thus be appreciated that operation of the plunger 3 will apply a compressive force to the “free” ends of the chubs within cylindrical tube 6 (opposite to end cap 7), causing the contents of the chubs to be driven toward nozzle 8. It will further be appreciated by one of ordinary skill that a variety of ways to pierce or “open” the ends of the chubs sealed to end cap 7a could be used to permit the contents of the chubs 9a, 9b to be expelled through nozzle 8 upon the application of a compressive force by a plunger 3 (e.g., the plunger of caulking gun 1). When the contents of the chubs 9a, 9b have been exhausted the tube portion (e.g., cylindrical tube 6a) can be removed from an applicator (e.g., caulking gun 1), after which the spent chubs and end cap/nozzle structure 7a, 8 can be extracted or separated from cylindrical tube 6a and thrown away or recycled. A fresh combined chub/end cap structure 7a, can then be reinserted into cylindrical tube 6a, which can then be placed back within caulking gun 1 to continue an application of material. It will thus be appreciated that the use and re-use of cylindrical tube 6a will result in a reduction of generated waste and an associated cost saving to the end user.

With particular reference to FIGS. 3, 4, 6 and 7, in an embodiment of the invention, where two or more chubs 9a, 9b are adhesively or otherwise sealed to a common end cap 7a in order to produce a multi-component extruded product, the individual chubs may be secured or otherwise held together at one or more points along their length through use of a fastener or fastening means. In the case of the particular embodiment shown in FIGS. 3, 4, 6 and 7, the two chubs are shown as having their exterior surfaces bonded together at single point. In this instance, the fastener or fastening means is an adhesive and the bonding between the respective chubs is accomplished through the application of a relatively small amount of glue or adhesive 12 between the exterior surfaces of the two adjacent chubs. In alternate embodiments, mechanical fasteners of a wide variety of different types and configurations could be used in place of, or to augment, glue 12. Glue 12 may be applied at approximately the midpoint 9c, 9d along the length of the two adjacent chubs. Alternately, in some applications it may be desirable for glue 12 to be applied approximately one-third of the distance from end cap 7a, and/or two-thirds of the distance from end cap 7a. Other positions or locations of glue 12 may also be possible. Various forms of glue or adhesive may be used. For reasons that will become apparent following an appreciation of the description that follows, in some instances it may be desirable to utilize a glue that is relatively frangible when it cures or hardens. In such cases the point of securement between adjacent chubs may be destroyed through application of a compressive force to the ends of the chubs by a plunger 3, when the chubs are inserted into cylindrical tube 6a and tube 6a is inserted into a caulking gun 1. Similarly, where a mechanical fastener is utilized, it may be a frangible fastener.

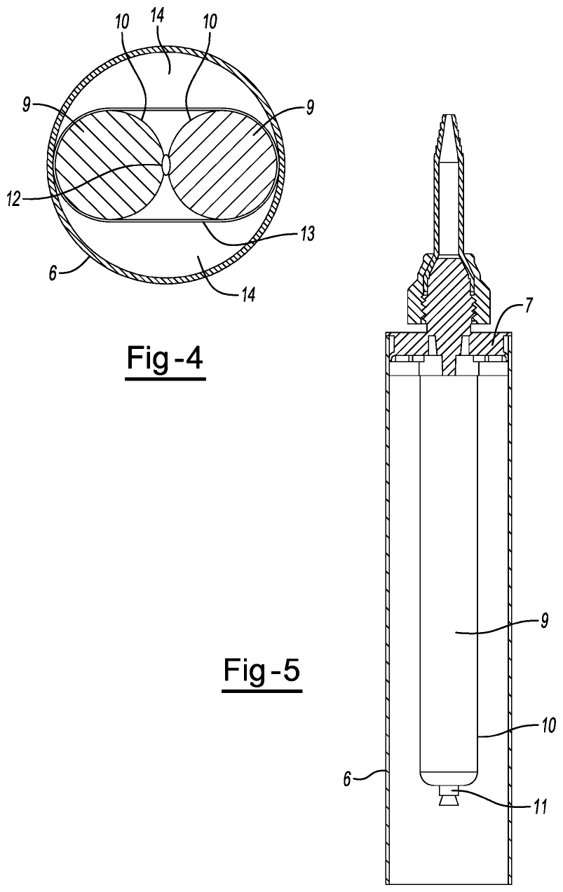

It is possible each of the plurality of chubs are kept generally aligned with each other over at least a portion of their lengths as their contents are compressed for dispensing. For example, the chubs may be assembled together and kept in place by a sheath or other band that wraps around two or more chubs. To illustrate, also shown in FIGS. 3, 4 6 and 7 is a band 13a that extends about the exterior 13b of the two adjacent chubs. Band 13a may take the form of a continuous band of material or, alternately, it may be a length of material wound or wrapped around the exterior of the adjacent chubs. Band 13a may be constructed from a variety of different materials including, but not limited to, rubber-like materials, polyolefin, polypropylene, polyester, nylon, or any one of a variety of other synthetic or natural products. It is contemplated that band 13a will typically extend fully around the exterior 13b of the adjacent chubs (as generally indicated in FIGS. 3 and 4). However, in a further embodiment band 13a may be in the form of elongate and rectangular strap, having opposed ends that are not joined, where each end is secured by gluing or otherwise fastening to a different chub.

It is expected that in many instances band 13a will compress the chubs 9a, 9b to a slight degree to help ensure that the band does not become accidentally removed or detached from the chubs when they are in transit, or before they are inserted within cylindrical tube a6. Alternately, band 13a could be secured to the exterior of the chubs through the use of an adhesive. In a still further embodiment, band 13a could be constructed from a material that creates sufficient friction between band 13a and the exterior surface of the chubs 13b to discourage the band from being unintentionally displaced from its position about the exterior of the chubs. As in the case of glue 12, band 13a may be positioned at approximately the midpoint 9c, 9d along the length of the chubs, e.g., at approximately one-third of the distance from end cap 7a, or at approximately two-thirds of the distance from end cap 7a. Other locations for band 13a may also be possible. It is also contemplated that in some instances it may be desirable for one or more bands 13a to be used on the same set of chubs. For certain applications one or more glue points 12 may be utilized together with one or more bands 13a on the same set of chubs.

It will be appreciated that the glue point or points, and/or the band or bands, will have the effect of helping to secure the two chubs (in the case of the depicted Figures) in a manner that will make the combined chubs more rigid than if there was no means to secure one chub to the other. That is, the normally, relatively flimsy, chubs will be held by glue 12 and/or band 13a in a more rigid combined structure, with each respective chub helping to support the adjacent chub. The added rigidity that is provided has been found to be advantageous to the chub/end cap structure, particularly prior to the structure being received within cylindrical tube 6a. For example, when a chub/end cap structure containing two or more chubs is grasped by an individual prior to being inserted into cylindrical tube 6, there may be a tendency for the individual to grab one of the chubs to move the combined structure from place to place. The relative flimsy nature of an individual chub, and the stresses that it must accommodate when a user grasps the individual chub and not both, can apply a significant stress to the adhesion or securement of the chub to end cap 7a, potentially causing the chub to be partially or completely detached from an adjacent chub and/or the end cap. In contrast, where glue 12 and/or band 13a is utilized to create a more rigid chub structure, grasping one of the chubs to move the combined structure from place to place will not have the same effect of placing as much stress upon the connection between the end of the chub that is grasped and end cap 7a, as the chub that is grasped will be supported, at least in part, by the adjacent chub.

It will be also appreciated by one of ordinary skill in the art having a thorough understanding of the invention that applying a continuous bead of glue along the entire length of the contact of adjacent chubs or applying a band of significant width or a significant number of bands, could have an undesired effect when attempting to advance a plunger within cylindrical tube 6a. For example, a continuous bead of glue along the length of the two chubs may not allow the contents of the chubs to be easily, effectively, or equally evacuated. Conventional wisdom has suggested that the individual chubs should not be bound to one another as doing so may have the effect mentioned above. However, the applicant has found that by applying a small amount of glue or adhesive to a single point or to a relative few points, along the length of the chub, and/or utilizing a relatively narrow band at a discrete location along the length of the chubs, an adequate amount of adhesion between the chubs is created to present a more rigid structure that is less likely to become damaged prior to being inserted into a tube portion (e.g., cylindrical tube 6), without hindering the ability to collapsed the chubs and expel their contents.

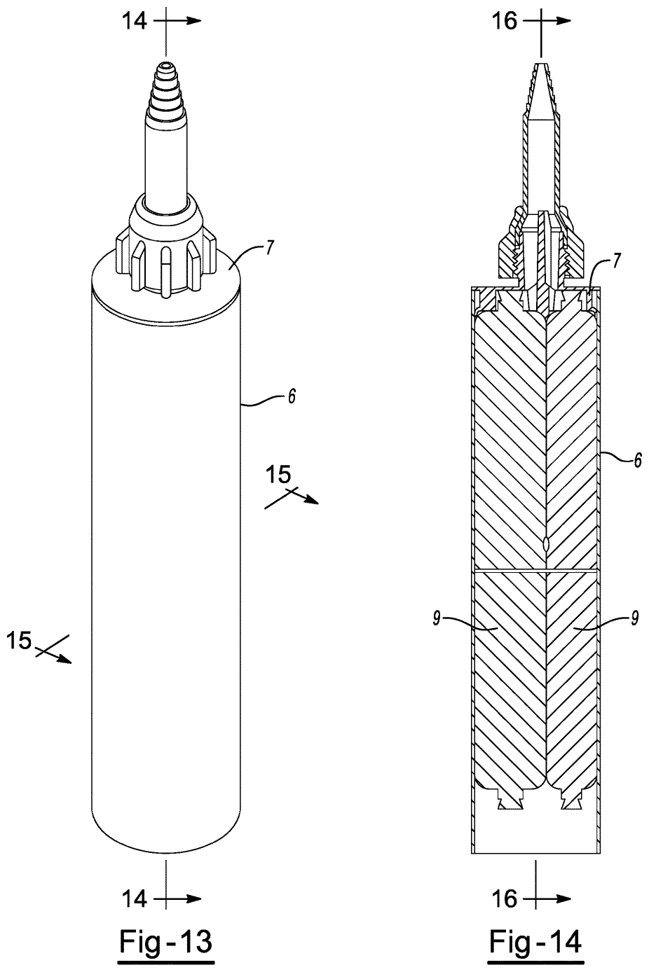

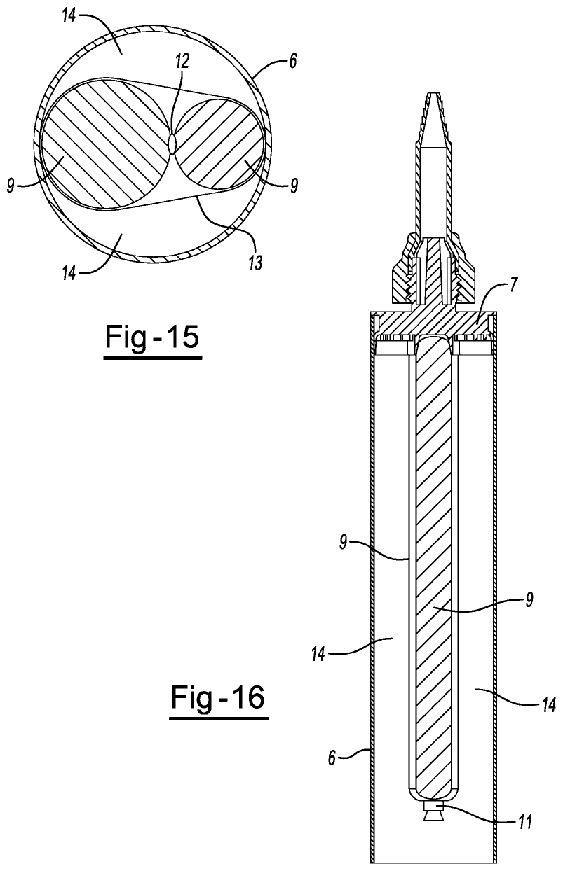

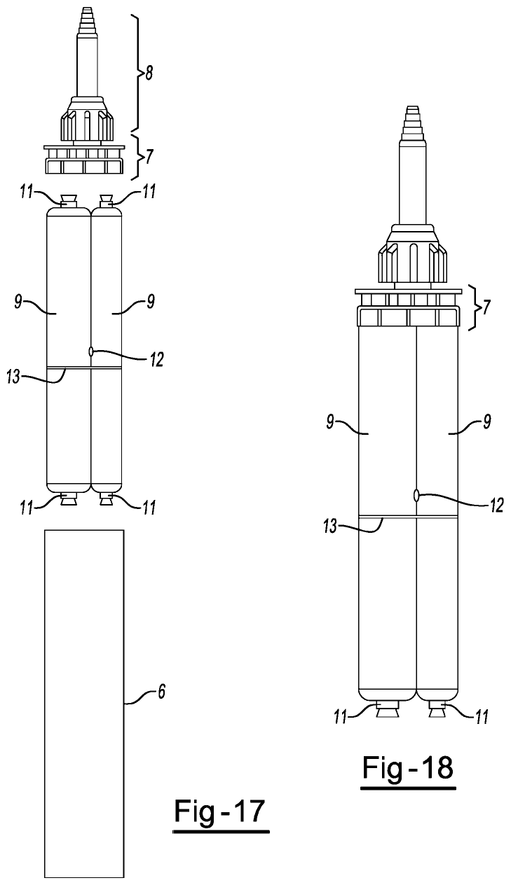

With particular reference to FIG. 4, a further advantage of utilizing glue 12 and/or band 13a is demonstrated. In the embodiment shown, two separate chubs 9a, 9b are received within the hollow interior of a tube portion (e.g., cylindrical tube 6a). In this instance both chubs 9a, 9b are of the same approximate cross-sectional diameter d, generally representing the ability to form a two-component product where the individual components are mixed in an approximate 1:1 ratio. In this instance it will be noted that there will be a significant void space 14 created within the hollow interior of the tube portion (e.g., cylindrical tube 6a), on opposite sides 6e, 6f of the pair of adjacent chubs 9a, 9b. For many products that are comprised of two components that are to be mixed together in nozzle 8, the individual components may be of different viscosities and/or densities. The applicant has found that in such cases there may be a tendency for a chub housing a higher viscosity component to potentially buckle or to be displaced laterally into void 14 as the plunger is advanced. Similarly, where one chub houses a component of a higher density than the other, there may be a tendency for the chub housing the lower density component to buckle or be displaced into void 14 as the plunger is advanced. If that were to occur, the compressive force supplied by the plunger may not be equally borne by the two chubs, resulting in potentially a disproportionate amount of the material from one chub being expelled and disrupting the desired ratio of the mixing of the two components in the nozzle 8. However, where glue 12 and/or band 13 is utilized to help hold the chubs more rigidly adjacent to one another, the applicant has found there will be a reduced tendency for one of the chubs to buckle outwardly or to be displaced into void 14, thereby reducing the potential for an interference with the desired mixing ratio.

Whereas FIGS. 2 through 7 depict a scenario where a pair of chubs 9a, 9b having approximately identical cross-sectional diameters d (i.e. a 1:1 mixing ratio) are utilized, FIGS. 13 through 18, while similar, demonstrate a situation where the cross-sectional area of one chub is approximately twice that of the other, generally representing a 2:1 ratio mixture. In this instance, and particularly with reference to FIG. 15, it will be noted that the considerably smaller cross-sectional area or diameter of the smaller chub will tend to increase the likelihood of that chub buckling or being displaced into void 14 when the ends of the two chubs 9a, 9b are compressed by the plunger. The applicant has found that in such instances the incorporation of glue 12 and/or band 13a can have an even more pronounced effect in helping to maintain a mixture of the two components at or near the desired ratio. Further, where a larger diameter chub 9e is secured in common with a small-diameter chub 9f to an end cap 7a, movement of the combined chub/end cup structure without the incorporation of glue 12 and/or band 13a stands an increased likelihood of a partial or full detachment of one of the chubs (and in particular the small diameter chub 9f) from the end cap 7a during transportation, storage, and handling prior to insertion of the combined chub structure into the hollow interior of cylindrical tube 6a. Here, the utilization of glue 12 and/or band 13a has again been found to have an even more significant effect than in the case of the embodiment of FIGS. 2-7.

In a further embodiment, band 13a could take the form of “shrink wrap” that is wound about the exterior surface of the adjacent chubs. The “shrink wrap” could be wound about the chubs in a relatively narrow band 13c, as in the case of band shown in the attached drawings. Alternately, a thin layer, or a relatively few thin layers, of “shrink wrap” could extend about a longer portion of the chubs. In this later scenario, it will be appreciated that, provided that the “shrink wrap” is relatively thin or that a relatively few layers are used, the “shrink wrap” is unlikely to have an appreciable negative effect on the ability of the materials within the chubs to be expelled at their desired ratios. That is, the thin, flexible, and pliable nature of “shrink wrap” is such that it will generally not tend to interfere with the compression of the chubs through an advancement of the plunger of a caulking gun.

Where 3 or more chubs are secured to a common end cap 7a, it will be understood that multiple glue points will be preferred to secure each chub to each chub that it is adjacent to. Where 3 or more chubs are utilized, the individual chubs may be supported through the use of band 13a or wrap that is placed about the combined exteriors of the multiple adjacent chubs.

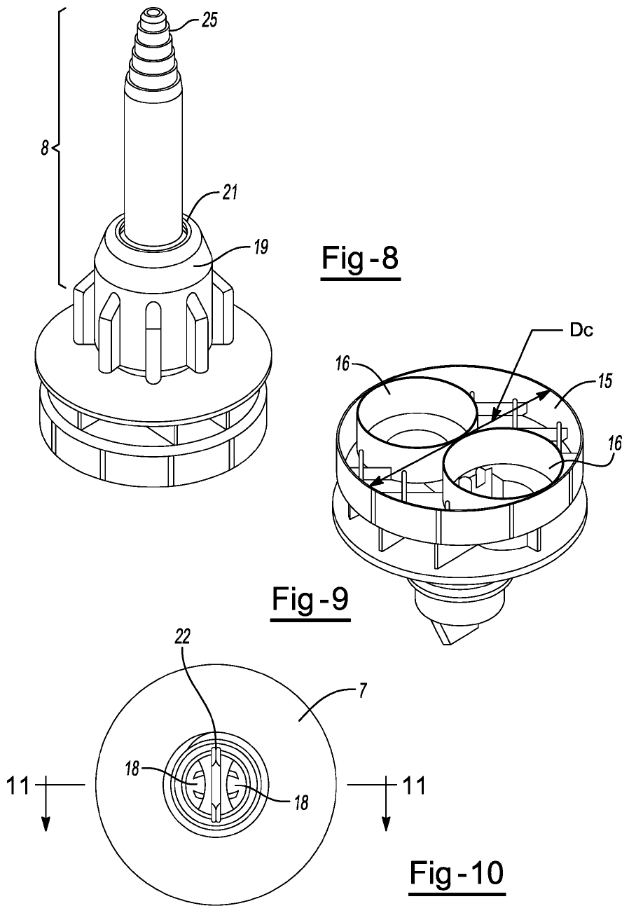

With specific reference to FIGS. 8 through 12, there is shown a representative embodiment of end cap 7a and nozzle 8. In this embodiment, end cap 7a is fitted with a downwardly extending skirt 15 having a diameter that is slightly less than the interior diameter td of cylindrical tube 6a such that skirt 15 may be slidably received within one end of the cylindrical tube. Preferably, the tolerances between skirt 15 and the interior diameter td of cylindrical tube 6a are such that the connection formed between the respective components is a friction fit. It is further preferable that skirt 15 be receivable within the internal diameter td of cylindrical tube 6a with sufficient friction that the two components will not readily and easily be separated from one another, while permitting the end cap 7a to be withdrawn from cylindrical tube 6a without the use of tools.

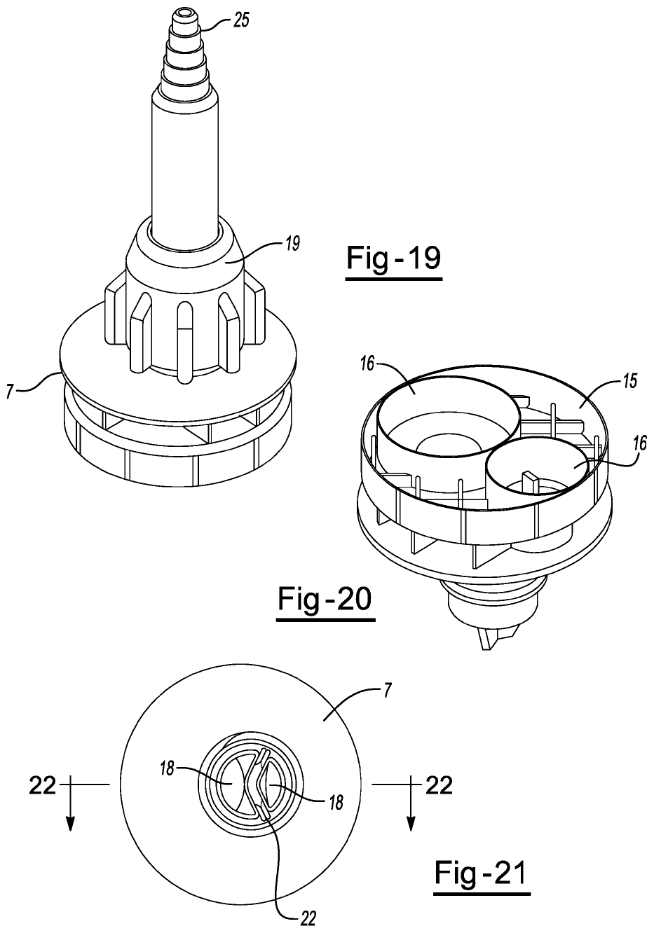

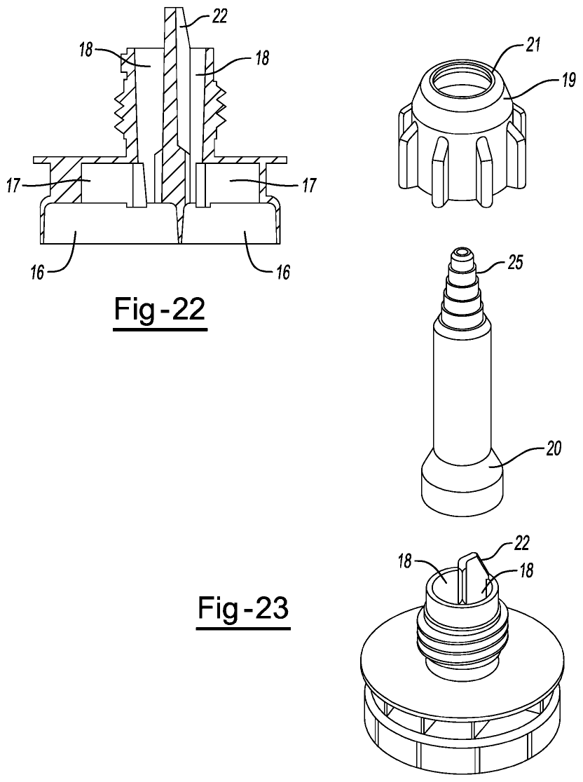

As shown in FIG. 9, end cap 7a may also have incorporated into it, and on its lower surface, a plurality of chub receiving tubes 16 that are of a diameter designed to receive the exterior surfaces of chubs that are specifically intended to be secured to end cap 7a. The embodiment of end cap 7a shown in FIG. 9 is intended to receive two chubs 9a, 9b having the same approximate cross-sectional diameter d (i.e., a 1:1 ratio extruded product). In the case of FIGS. 19 through 23, chub receiving tubes 16 are of different diameters, as would be the case for two chubs that are utilized to form a 2:1 ratio product. Other versions and configurations of chub receiving tubes could be formed within the lower surface of end cap 7a, including the formation of three or more chub receiving tubes. In most instances it is expected that the ends of the chubs will be glued within tubes 16, although other ways to secure the chubs are possible. Where end cap 7a is designed for use with chubs having ends secured or closed through the use of clips 11, end cap 7a may be fitted with clip receiving compartments 17 which effectively house clips 11 when the ends of the chub are glued or otherwise secured within tubes 16.

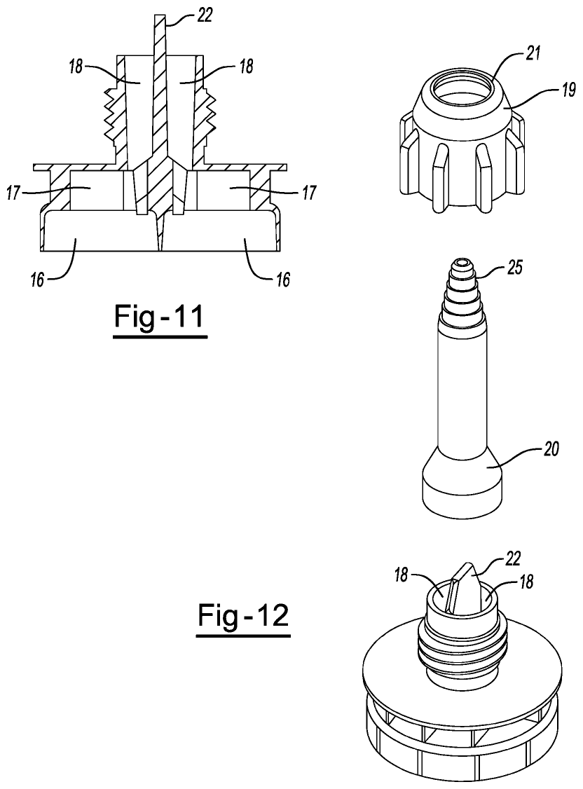

In many instances the individual components of a multi-component extruded product are designed to react with one another when mixed together (e.g., a two-part epoxy). For that reason, end cap 7a has been designed to maintain a physical barrier between the components of the individual chubs until those components are extruded into nozzle 8. FIG. 11 shows, in section, an exemplary embodiment of an end cap 7a specifically designed for a two-component product. Here, end cap 7a includes a manifold 7m that is comprised of a pair of separate and distinct flow passageways 18 that connect each clip receiving compartment 17 to a lower portion of nozzle 8. In this manner, a tool or other device may be inserted into flow passageways 18 to pierce the chubs secured within tube 16 so that pressure applied to the opposite end of the chubs by the plunger of caulking gun 1 will cause material within the individual chubs to flow into their respective clip receiving compartments 17. From there, the materials will flow through individual flow passageways 18, that are separated by a barrier or other partition wall 22, and into a bottom end of nozzle 8. In FIGS. 21, 22, and 23 it will be noted that barrier or other partition wall 22 is curved or non-linear in a lateral direction to account for the fact that the mixing ratio in that embodiment is not 1:1. In alternate embodiments, where three or more chubs are secured to a common end cap 7a, there may be a dedicated flow passageway 18 for each chub and multiple barriers or partition walls 22, or barrier or partition wall 22 having multiple portions or wings, to define the multiple, separated, flow passageways.

It will thus be appreciated that by maintaining a separation between the different components housed within individual chubs at all times when the components are within end cap 7a, no reaction between the components will be allowed to occur until the components exit the end cap. This permits a user to remove nozzle 8 before the chubs have been fully exhausted, to enclose the upper portion of end cap 7a, and to preserve the components for use at a later point. In that regard end cap 7a may be provided with an enclosure cap 7n or other closure device that can be used to effectively seal off or enclose the upper or outer ends of flow channels 18 when nozzle 8 has been removed.

With respect to the construction of nozzle 8, the nozzle will essentially comprise a static mixer 25b and an applicator end 25a. The static mixer may be of any of a wide variety of currently available nozzles/mixers that serve to mix or otherwise combine a plurality of components as they are advanced therethrough. The structure and function of such static mixers will be understood by those of skill in the art. Such individuals will appreciate that applicable static mixers could include spiral mixers, sheer mixing mechanisms, and/or other physical structures serving to mix or combine the particular components at hand. The applicator end 25a of nozzle 8 may be any commonly available or commonly used applicator for extruded products, including caulking and silicone applicators.

In the embodiment shown, nozzle 8 includes a nut 19 that releasably secures the nozzle to the upper end of end cap 7a and about flow passageways 18. In this instance, the lower portion of nozzle 18 is fitted with a flared portion 20 and the bore through nut 19 has a hole 21 in its upper end with a diameter smaller than the diameter of flared portion 20. Sliding nut 19 over the upper end of nozzle 8 thus causes nut 19 to bear upon the flared portion 20. Threading nut 19 onto the upper portion of end cap 7 will thereby allow the nut to secure nozzle 8 in place with flared portion 20 received about the upper ends of flow passageways 18. As alluded to previously, if the task at hand has been completed before the chubs received within cylindrical tube 6a have been fully evacuated, nut 19 may be unthreaded from its connection with end cap 7a and nozzle 8 disposed of. The remaining end cap structure, having not permitted a contact between the components of the respective chubs, can then be sealed and reused at a later time.

In addition to the above, the following teachings apply to each of the embodiments. As seen from the drawings, there are a number of other structural features that may be selected to help improve performance and/or facilitate manufacturing, and/or achieve some other technical benefit (e.g., reduced land fill material at end of life). Among the many variations, without limitation, the cap may have a circular cross-sectional geometry in a plane transverse to the longitudinal axis. An opening of the cap through which the contents of the chubs exit the assembly may be radially offset relative to the center of the cap. The cap may have a length Lc from its most proximal location to its most distal location. The cap may have a diameter Dc or other largest dimension. The ratio of Lc to Dc may range from 0.5:1 to 3:1, preferably about 0.8:1 to 2:1.

It is to be understood that what has been described are the preferred embodiments of the invention. The scope of the claims should not be limited by the preferred embodiments set forth above but should be given the broadest interpretation consistent with the description as a whole.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist of, or consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A dispenser assembly, comprising:
a cap portion configured to receive one or more chubs containing one or more components for dispensing wherein the cap portion includes a proximal end portion that includes a plurality of chub receiving tubes, into which chubs can be sealingly inserted and held in place by an adhesive; and
an elongated mounting tube portion having a first end and a second end and a longitudinal axis and configured to carry the plunger and cap with the one or more elongated packages positioned between the cap and plunger and a variable internal volume defined between the plunger and the cap portion;
wherein one more of the chubs have a diameter that differs from one or more other chubs;
wherein the chubs are assembled together and kept in place by a sheath or other band that wraps around two or more of the chubs and/or an adhesive bonds adjoining chubs to each other; and
wherein the cap portion is configured to:
(i) sealingly receive the one or more chubs;
(ii) allow and direct chub contents to flow at least partially therethrough;
(iii) maintain separation between the contents of the one or more chubs;
(iv) maintain orthogonally oriented alignment of the cap portion throughout dispensing;
(v) be arranged adjacent to the tube in a manner that enables the assembly to be transported and loaded into an applicator and to be disassembled manually;
(vi) receive and/or carry a piercing device; and optionally
(vii) meter the one or more components.

2. The assembly of claim 1 wherein the cap portion is configured to include one or more discrete flow paths that are physically separated from one another while enclosed by the cap within the assembly.

3. The assembly of claim 1, wherein the cap portion has at least two discrete flow paths defined by a plurality of longitudinally adjoining chambers that are each defined by an internal wall structure so that the chambers are in fluid communication with each other and progressively narrow in cross sectional area in stepped decrements progressing toward a distal end, and also converging radially inward.

4. The assembly of claim 3, wherein the cap portion includes a mixing nozzle mount located at or near the distal end, and optionally defines the distal end of the cap;
wherein the nozzle amount has a threaded neck portion and includes a longitudinally extending inner partition wall to maintain physical separation of contents of respective chubs until the contents are expelled external of the cap portion.

5. The assembly of claim 1, wherein the nozzle mount of the cap portion includes a longitudinally extending inner partition wall to maintain physical separation of contents of respective chubs until the contents are expelled external of the cap; and optionally
wherein the inner partition wall extends distally such that it would penetrate through a plane that is defined within a mixing nozzle that is threadingly secured to the nozzle mount.

6. The assembly of claim 2, wherein separation of the contents of the chubs is maintained until the contents are expelled from the cap and located in a mixing nozzle.

7. The assembly of claim 1, wherein the assembly is configured to dispense two components for mixing to form an epoxy adhesive.

8. (canceled)

9. The assembly of claim 7, herein
wherein the cap portion includes a nozzle mount distally located relative to the chub receiving tubes and one or more chambers located at least partially between the nozzle mount and the chub receiving tubes into which a distal end and optionally a clip of a chub is located during dispensing.

10. The assembly of claim 1, wherein the assembly includes a plunger wherein the plunger is configured to: (A) (i) bear against an inside surface of the tube; (ii) be translated by an external force in a fore and/or aft direction along the longitudinal axis; (iii) remain aligned with the longitudinal axis during and throughout dispensing; (iv) remain generally orthogonally oriented during fore and/or aft translation; (v) avoid pressure build-up within the tube portion as it translates; (vi) apply a dispensing pressure to the one or more packages; and (vii) maintain the package within a variable internal volume throughout a dispensing operation; and/or (B) include an interior wall having (i) a diameter or other largest dimension in a plane transverse to the longitudinal axis of the tube portion, and (ii) an outer periphery that includes a forward and/or rearward extending circumferential flange, and the forward and/or rearward extending flanges optionally each extend forwardly and/or rearwardly along the direction of the longitudinal axis in an amount that is at least 10 to 50% of the diameter or other largest dimension and/or the forward and/or rearward extending flanges optionally each include a radially extending slot.

11. The assembly of claim 1, wherein the tube portion has a constant profile, optionally cylindrical, along a majority of its length.

12. The assembly of claim 4, wherein the assembly includes a plurality of chubs that are aligned parallel with each other within the tube portion and sealingly attached to the cap portion at or near the distal ends of the chubs.

13. (canceled)

14. The assembly of claim 2, wherein exactly two chubs are received by the cap portion.

15. The assembly of claim 2, wherein exactly three chubs are received by the cap portion.

16-17. (canceled)

18. The assembly of claim 14, wherein the cap is adapted to meter the one or more components.

19. The assembly of claim 1 wherein the chubs are wrapped with a shrink wrap.

20. The assembly of claim 19, wherein the shrink wrap covers substantially the entirety of the chubs.

21. The assembly of claim 19, wherein the shrink wrap comprises a single layer of material.

22. The assembly of claim 19, wherein the shrink wrap comprises a plurality of layers.

23.-24. (canceled)

25. A method of dispensing an adhesive that includes the steps of:
inserting a chub containing ingredients for forming a bead into an assembly according to claim 1;
locating the assembly into an applicator capable of applying pressure against a plunger;
puncturing the chub; and
applying pressure to force the ingredients out of the chub through an opening made by the puncturing and through the cap.

26. The method of claim 25, wherein the method includes the steps of:
removing and discarding a used cap and chub after forcing the ingredients out of the chub while maintaining the plunger for later use.

27-30. (canceled)
